(19) United States
(12) Patent Application Publication
(10) Pub. No.: US 2022/0147319 A1
(43) Pub. Date: May 12, 2022

(54) METHOD AND SYSTEM FOR MANAGING THE OPERATION OF A GROUP OF SEVERAL CONNECTED OBJECTS

(71) Applicant: STMicroelectronics (Grand Ouest) SAS, Le Mans (FR)

(72) Inventor: Frederic Ruelle, Marigne-Laille (FR)

(21) Appl. No.: 17/582,748

(22) Filed: Jan. 24, 2022

Related U.S. Application Data
(63) Continuation-in-part of application No. 16/503,911, filed on Jul. 5, 2019.
Application No. 16/503,911 is a continuation-in-part of application No. 17/007,599, filed on Aug. 31, 2020.

(30) Foreign Application Priority Data
Jul. 16, 2018 (FR) 1856546
Sep. 6, 2019 (FR) 1909823

(51) Int. Cl. G06F 7/58

(52) U.S. Cl. CPC G06F 7/588

(57) ABSTRACT

In an embodiment a method for generating a random number includes selecting, by a first object, first symbols from an entropy pool of the first object, wherein the first object is an object of a group of mutually connected objects which are substantially identical, and wherein the entropy pool is fed with second symbols by objects of the group of mutually connected objects, applying, by the first object, a hash function to the first symbols to generate a random seed and generating, by the first object, the random number from the random seed.

### CROSS-REFERENCE TO RELATED APPLICATIONS

This application is a continuation-in-part of U.S. patent application Ser. No. 16/503,911, filed on Jul. 5, 2019, which claims priority to French Patent Application No. 1856546, filed on Jul. 16, 2018, and of U.S. patent application Ser. No. 17/007,599, filed on Aug. 31, 2020, which claims priority to French Patent Application No. 1909823, filed on Sep. 6, 2019, all applications are hereby incorporated herein by reference.

### TECHNICAL FIELD

Embodiments relate to a method and system for managing the operation of a group of connected objects.

### BACKGROUND

Generally, a connected object always remains in communication with another connected object or a server via an internet network, and is ready for one or more updates of its firmware in order to correct current operating errors or to acquire new features.

Nevertheless, such communications via the internet network are not always secure and unfortunately often open the possibility of modifications of the connected object via malicious software, or even the possibility of hacking, which could result in significant damage.

A conventional solution involves using, for each connected object, a mechanism based on cryptographic resources, for example, a digital signature, so as to verify the authorization of each intervention of this connected object. However, this mechanism is rolled out and executed individually on each connected object.

Once the malicious software or hacking operations have succeeded, despite everything, in taking control of the connected object, the latter generally no longer responds to security requests based, for example, on the digital signature and transmitted, for example, by a remote server. From the view of the remote server, the connected object is disconnected or in a failure condition.

Consequently, it is not always easy to identify the operating state of a connected object and it is all the more difficult to automatically restore a potentially modified or hacked connected object.

### SUMMARY

Implementations and embodiments of the invention relate to the internet of objects, commonly known by the abbreviation IoT (Internet of Things). Particular embodiments relate to objects connected to the internet network in the broad sense, i.e., including, for example, the local area network (LAN) and the wide area network (WAN), which are intended to mutually communicate data and perform practical and more or less simple operations, such as connected luminous intensity detectors, connected temperature detectors, connected door-opening detectors and connected electrical switches.

Embodiments of the invention propose a technical solution of low complexity, low communication power consumption and low cost, providing for enhancing the security of mutually coupled connected objects by
self-evaluations between each other,
grouped verifications for each intervention of the connected objects, and
possible restorations for the modified or hacked connected object or objects,
without necessarily needing to have a server involved which is generally busy and capable of being attacked and neutralized by hackers.

According to one aspect, a method for managing the operation of a group of several connected objects comprises exchanges of information between at least two connected objects of the group, relating to at least one state of each connected object participating in these exchanges of information. The method also comprises a triggering of at least one action on at least one connected object having participated in these exchanges according to the information received by this object.

Such a method for managing the operation of connected objects by group advantageously provides for reducing the possibility of modifications via malicious software and the risk of hacking since connected objects in the same group can communicate with each other so as to perform periodic self-evaluations (between one another) and possible restorations if an abnormality in the operation of one or more connected objects in the group is detected.

It is appropriate to note that the size and topology of the group can, for example, in this case be dynamic. In other words, a connected object can be dynamically associated with or dissociated from the group so as to enhance the unpredictable character of the group. Thus, the security of the group is advantageously strengthened.

According to one implementation, the exchanges comprise periodic exchanges between the connected objects in the group, of first items of information relating to an operating state of the connected objects, and
the triggering comprises an issuing of a first warning signal if the operating state of at least one connected object is incorrect and/or an issuing of a second warning signal in the event of a failure of the transmission, by at least one of the objects to the other objects, of first items of information relating to its operating state.

It is appropriate to note that a failure of transmission of information relating to the operating state of a connected object often means that the connected object has become faulty or that the connected object has been hacked.

Such a method provides for a periodic check on the operating state of each connected object in the group so as to identify one or more connected objects having irregular operating states.

The exchanges can, for example, additionally comprise periodic exchanges, between the connected objects in the group, of at least one parameter measured locally by each connected object, and
the triggering can, for example, additionally comprise the issuing of the second warning signal if
the periodic exchanges of the first items of information are successful,
all the operating states are identical, and
the at least one measured parameter of at least one connected object exceeds a nominal range of the nominal value of the at least one parameter, or a change of the at least one measured parameter of at least one connected object is different from that observed for the remainder of the group.

Advantageously, the correct operation of a connected object can be monitored by comparing the same parameter measured by the connected objects in a group. When the parameter measured by a connected object is too different from the nominal value, this connected object can be in a failure condition or have been modified or hacked.

It is appropriate to note that a change of the at least one measured parameter of at least one connected object is different from that observed for the remainder of the group when this change is, for example, rising with respect to falling changes observed by the remainder of the group.

According to another implementation, the exchanges comprise exchanges, following a firmware update request of at least one connected object in the group, of second items of information representative of a firmware update request state of the connected objects, and
the triggering comprises a suspension of the firmware update request if at least one exchange of the second items of information is not successful or if the update request state of the at least one connected object making the update request is different from the update request state of at least one other connected object in the group.

Advantageously, with such a method, the update request of each connected object in the group is verified by comparing it with those of other connected objects in the group so as to strengthen the security of the group.

According to another implementation, the method additionally comprises an election step for the connected objects in the group so as to determine an elected connected object.

The exchanges comprise exchanges, within a chosen duration following a firmware update of the elected connected object, of third items of information representative of a firmware update state of the elected object. The triggering can comprise a firmware update of the other connected objects in the group if the update state of the elected connected object is positive. Alternatively, a suspension of firmware updates of the other connected objects in the group and an issuing of a third warning signal can occur if the update state of the elected connected object is negative or at least one exchange of the third items of information of the connected objects is not successful.

A positive state is, for example, a successful firmware update while a negative state is, for example, an update that has failed.

In other words, the firmware update of the other connected objects in the group is carried out only if the update state of the elected connected object that has already had the update is positive. Otherwise, a warning signal is generated so as to indicate a possible security problem for the connected objects in the group.

By way of non-limiting example, the exchanges can comprise exchanges between the connected objects of fourth items of information representative of a state of security of the connected objects. The triggering can comprise a determination of an authentic state of all the connected objects if the states of security of all the connected objects are identical, and an issuing of a fourth warning signal and a determination of a state of insecurity if the state of security of at least one connected object is different from those of the other connected objects.

Such a method also advantageously provides for a verification of the state of security, for example, via a digital signature, of the connected objects in the group.

According to yet another implementation, the exchanges comprise exchanges, between a first connected object in the group having failing firmware and at least a second connected object in the group, of fifth items of information representative of a firmware operating state of the first connected object and of the at least second connected object. The triggering comprises, if the firmware operating state of the at least second connected object is positive, a delivery of operational firmware of the at least second connected object to the first connected object and a firmware update of the first connected object with the operational firmware.

A positive firmware operating state is, for example, a correct or operational functioning of the firmware.

Here also, such a method provides for locating a failing or hacked connected object in the group with the aid of another connected object in the group which exhibits correct operation.

The delivery can, for example, be carried out from the at least second connected object or from a separate remote server.

By way of non-limiting indication, the firmware operating state comprises the version of the firmware used and a number of errors detected within a chosen duration, or a digital signature of the firmware.

According to another implementation, the connected objects are identical or compatible, and the exchanges and the at least one action are protected by symmetric cryptography.

Such a symmetric key is specific to the group and therefore does not allow a hacker to hack into the group, since a replicated object does not have the symmetric key.

As a variant, the connected objects can, for example, be identical or compatible. The exchanges and the at least one action can, for example, be protected by asymmetric cryptography.

According to another aspect, there is proposed an operation management system for a group of several mutually coupled connected objects and including a control module associated with each object.

Each control module has an exchange module configured to exchange, between at least two connected objects in the group, information relating to at least one state of each connected object participating in these exchanges of information, and a processing module configured to trigger at least one action on at least one connected object having participated in these exchanges according to the information received by this object.

Such a system advantageously provides improved protection against cyber attacks since the control module is better isolated from data input devices, such as peripheral devices and data exchange interfaces, incorporated in each connected object.

According to one embodiment, the exchange module is configured to periodically exchange between the connected objects in the group, first items of information relating to an operating state of the connected objects, and the processing module is configured to issue a first warning signal if the operating state of at least one connected object is incorrect and/or a second warning signal in the event of a failure of the transmission, by at least one of the objects to the other objects, of first items of information relating to its operating state.

By way of non-limiting example, the exchange module can additionally be configured to periodically exchange between the connected objects in the group at least one parameter measured locally by each connected object. The processing module can additionally be configured to issue the second warning signal if the exchanges of the first items of information are successful, all the operating states are identical, and the at least one measured parameter of at least one connected object exceeds a nominal range of the nominal value of the at least one parameter, or a change of the at least one measured parameter of at least one connected object is different from that observed for the remainder of the group.

According to another embodiment, the exchange module is additionally configured to exchange, following a firmware update request of at least one connected object in the group, second items of information representative of a firmware update request state of the connected objects. The processing module is additionally configured to suspend the firmware update request if at least one exchange of the second items of information is not successful or if the update request state of the at least one connected object making the update request is different from the update request state of at least one other connected object in the group.

According to yet another embodiment, the control module additionally comprises an election module configured to determine an elected connected object in the group.

The exchange module is additionally configured to exchange, within a chosen duration following a firmware update of the elected connected object, third items of information representative of a firmware update state of the elected object. The processing module is additionally configured to update firmware of the other connected objects in the group if the update state of the elected connected object is positive, or suspend firmware updates of the other connected objects in the group and issue a third warning signal if the update state of the elected connected object is negative or at least one exchange of the third items of information of the connected objects is not successful.

By way of non-limiting example, the exchange module can additionally be configured to exchange, between the connected objects, fourth items of information representative of a state of security of the connected objects. The processing module can additionally be configured to determine an authentic state of all the connected objects if the states of security of all the connected objects are identical, and issue a fourth warning signal and determine a state of insecurity if the state of security of at least one connected object is different from those of the other connected objects.

According to another embodiment, the exchange module is additionally configured to exchange, between a first connected object in the group having failing firmware and at least a second connected object in the group, fifth items of information representative of a firmware operating state of the first connected object and of the at least second connected object. The processing module is additionally configured to deliver, if the firmware operating state of the at least second connected object is positive, operational firmware of the at least second connected object to the first connected object, and update the firmware of the first connected object with the operational firmware.

The processing module can, for example, be configured to deliver the operational firmware from the at least second connected object or from a separate remote server.

The firmware operating state can, for example, comprise the version of the firmware used and a number of errors detected within a chosen duration, or a digital signature of the firmware.

According to another embodiment, the connected objects are identical or compatible, and each control module additionally comprises a protection module configured to protect the exchange module and the processing module by symmetric cryptography.

As a variant, the connected objects can, for example, be identical or compatible. Each control module can, for example, additionally comprise a protection module configured to protect the exchange module and the processing module by asymmetric cryptography.

By way of non-limiting indication, the connected objects can, for example, be objects chosen from the group formed by the following objects: connected bulbs, connected sensors, connected enclosures and connected monitoring equipment.

According to another aspect, there is proposed a connected object belonging to the system defined above.

### BRIEF DESCRIPTION OF THE DRAWINGS

Other advantages and features of the invention will become clearer upon examining the detailed description of implementations and embodiments, which are not at all limiting, and accompanying drawings in which:

FIGS. 1 to 11 schematically illustrate implementations and embodiments of the invention.

### DETAILED DESCRIPTION OF ILLUSTRATIVE EMBODIMENTS

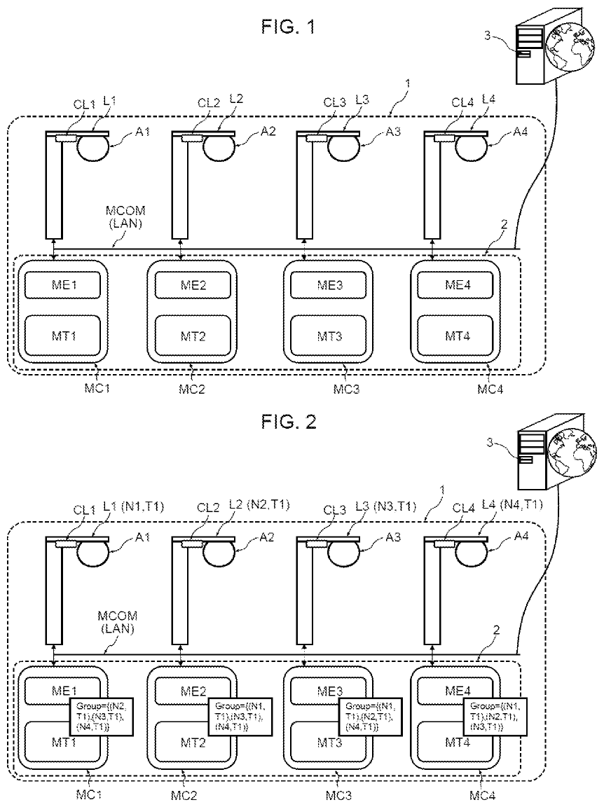

FIG. 1 illustrates an example embodiment of a group 1 of several connected objects, in this case for example, four connected external street lights L1, L2, L3, L4, and an operation management system 2 for the group 1.

By way of non-limiting example, the structures and operation of the four street lights L1, L2, L3, L4 are compatible, perhaps even identical, and these four street lights L1, L2, L3, L4 are located in the same street.

Each street light L1, L2, L3, L4 includes a connected bulb A1, A2, A3, A4 configured to be on or off in a controlled manner, and a connected luminosity sensor CL1, CL2, CL3, CL4 configured to detect the intensity of luminosity around the connected bulb A1, A2, A3, A4.

The four street lights L1, L2, L3, L4 are mutually coupled via communication network MCOM, in this case for example, via a local area network LAN, and coupled to a remote control server 3, for example, via the internet network.

The operation management system 2 includes, for each street light L1, L2, L3, L4, a control module MC1, MC2, MC3, MC4 coupled to the corresponding connected bulb A1, A2, A3, A4 and to the corresponding connected luminosity sensor CL1, CL2, CL3, CL4 and configured to manage the operation of the corresponding street light L1, L2, L3, L4 and strengthen the security of the group.

It is appropriate to note that each control module MC1, MC2, MC3, MC4 can be coupled to the local area network LAN so as to communicate with the other control modules MC1, MC2, MC3, MC4 in the group 1 via the local area network LAN, or have an application programming interface (API) enabling communications via dedicated software applications, using static IP (Internet Protocol) addresses, or even a network that is separate and reserved for the communication network MCOM. In the latter case, data exchanges within the group are advantageously not visible to a possible hacker who would attack the connected object via the main network.

Each control module MC1, MC2, MC3, MC4 is, for example, produced in the form of an STM32®L4 microcontroller, of the company STMicroelectronics, known to the person skilled in the art.

Advantageously, such a control module MC1, MC2, MC3, MC4 in the microcontroller can be isolated in a virtual manner so as to allow the microcontroller to perform other operations such as controlling the connected bulb.

By way of non-limiting example, communications between the street lights L1, L2, L3, L4 and the operation management system 2 can be secured with the aid of symmetric cryptography, known to the person skilled in the art, for example, with a common private key.

As an alternative solution, the communications can also be protected with the aid of asymmetric cryptography, known to the person skilled in the art, for example, with public and private keys.

Each control module MC1, MC2, MC3, MC4 comprises exchange modules ME1, ME2, ME3, ME4 configured to exchange between at least two connected objects in the group 1 information relating to the at least one state of each connected object participating in these exchanges of information, and a processor MT1, MT2, MT3, MT4 configured to trigger at least one action on at least one connected object having participated in these exchanges according to the information received by this object.

The exchange modules ME1, ME2, ME3, ME4 are implemented in the form of software applications and can be updated directly when the control modules MC1, MC2, MC3, MC4 are in operation.

As a variant, the exchange modules ME1, ME2, ME3, ME4 can be implemented in a fixed manner like the control modules MC1, MC2, MC3, MC4.

However, the processing modules MT1, MT2, MT3, MT4 can never be updated when the control modules MC1, MC2, MC3, MC4 are in operation so as to ensure the security of the group 1.

As a variant, the processing modules MT1, MT2, MT3, MT4 can, for example, never be updated in order to prevent possible physical attacks of the operation management system 2.

Reference is now made to FIG. 2 to illustrate an example of a step referred to as “discovery” of the operation management system 2 of the group 1.

In this discovery step, the four street lights L1, L2, L3, L4 and the control modules MC1, MC2, MC3, MC4 are mutually coupled via the local area network LAN.

Each street light L1, L2, L3, L4 has an identity number N1, N2, N3, N4 for the control modules MC1, MC2, MC3, MC4 to be able to identify them and a type number to recognize its characteristics. The four street lights are identical and therefore each have the same type number, in this case for example, T1.

When the group 1 of the connected street lights L1, L2, L3, L4 is operational for the first time, the exchange modules ME1, ME2, ME3, ME4 of each control module MC1, MC2, MC3, MC4 are configured to exchange with its corresponding street light L1, L2, L3, L4 and the other street lights in the group 1 so as to retrieve the identity numbers N1, N2, N3, N4 and the type numbers T1 of all the street lights and then deliver these identity numbers N1, N2, N3, N4 and the type numbers T1 to the corresponding processing modules MT1, MT2, MT3, MT4.

The processing modules MT1, MT2, MT3, MT4 of each control module MC1, MC2, MC3, MC4 are configured to save, respectively, the identity numbers of the other street lights in the group 1.

For example, for the processing module MT1 of the control module MC1, the saved identity numbers are N2, N3 and N4.

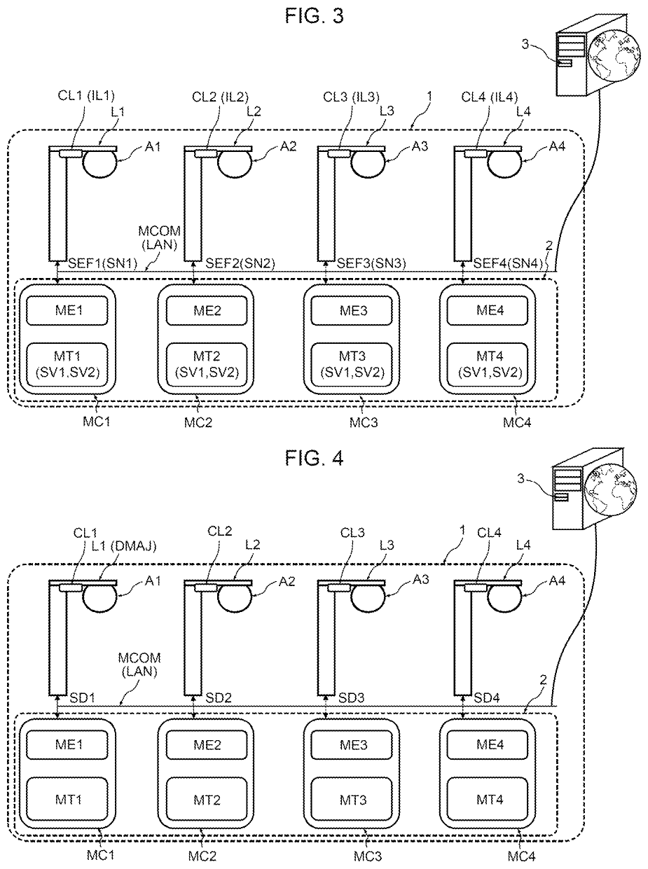

Reference is now made to FIGS. 3 to 7 to illustrate example implementations of the operation management system 2 for the group 1.

In the example illustrated in FIG. 3, there is illustrated an example implementation of the monitoring of the operating state of the connected street lights L1, L2, L3, L4 in the group 1.

The exchange modules ME1, ME2, ME3, ME4 of each control module MC1, MC2, MC3, MC4 are configured to periodically exchange with each other first items of information relating to an operating state of the connected street lights L1, L2, L3, L4, in this case for example, an operating state signal SEF1, SEF2, SEF3, SEF4 of each street light L1, L2, L3, L4.

Each operating state signal SEF1, SEF2, SEF3, SEF4 includes, for example, a digital signature SN1, SN2, SN3, SN4 calculated with the aid of a symmetric key common to the connected street lights L1, L2, L3, 14 in the group 1 in order to facilitate the verification of the operating state of each street light L1, L2, L3, L4.

If at least one operating state of these street lights L1, L2, L3, L4 is incorrect, in other words at least one digital signature SN1, SN2, SN3, SN4 is incorrect, or at least one exchange between these street lights L1, L2, L3, L4 is not successful, i.e., the verification of at least one signature SN1, SN2, SN3, SN4 has not succeeded, the processing modules MT1, MT2, MT3, MT4 of each control module MC1, MC2, MC3, MC4 are configured to issue a first warning signal SV1 so as to alert about the abnormality in the group 1.

The exchange modules ME1, ME2, ME3, ME4 of each control module MC1, MC2, MC3, MC4 are additionally configured to periodically exchange with each other at least one parameter measured locally by each connected luminosity sensor CL1, CL2, CL3, CL4, in this case for example, a signal representative of the luminous intensity IL1, IL2, IL3, IL4 measured by each connected luminosity sensor CL1, CL2, CL3, CL4.

Since these street lights L1, L2, L3, L4 are located in the same street, the temporal transition of the luminous intensity measured by each connected luminosity sensor CL1, CL2, CL3, CL4 is anticipated to be similar and in the same direction.

The processing modules MT1, MT2, MT3, MT4 of each control module MC1, MC2, MC3, MC4 are additionally configured to issue a second warning signal SV2 so as to indicate an abnormality of the at least one street light L1, L2, L3, L4 in the group 1, if the verification of the digital signature SN1, SN2, SN3, SN4 of at least one street light L1, L2, L3, L4 is successful but the luminous intensity IL1, IL2, IL3, IL4 measured by each connected luminosity sensor CL1, CL2, CL3, CL4 exceeds the nominal range, or if a change of at least one measured luminous intensity IL1, IL2, IL3, IL4 is different from that observed for the remainder of the group 1 (for example, the measured luminous intensity IL1 has a rising change and the other measured intensities IL2, IL3, IL4 have a falling change).

By way of example, the first warning signal SV1 and the second warning signal SV2 can be identical.

FIG. 4 illustrates an example implementation of the operation management system 2 when the exchange module of at least one connected street light in the group 1, in this case for example, the street light L1, issues a firmware update request DMAJ.

Following this update request DMAJ, the exchange modules ME1, ME2, ME3, ME4 of each control module MC1, MC2, MC3, MC4 are configured to exchange two items of information representative of a firmware update request state of the street lights L1, L2, L3, L4, in this case for example, a request signal SD1, SD2, SD3, SD4, so as to verify whether the firmware update request DMAJ is synchronized with the other street lights L2, L3, L4 in the group 1.

The processing modules MT1, MT2, MT3, MT4 are then configured to suspend the firmware update request DMAJ if at least one exchange of the request signals SD1, SD2, SD3, SD4 is not successful, or if the update request state of the street light L1 making the update request DMAJ is different from the update request state of at least one other street light L2, L3, L4 in the group 1.

When the at least one exchange is not successful, it is possible that this or these exchanges are blocked by the street light L1 making the firmware update request DMAJ.

For the case in which the update request DMAJ is not synchronized with the other street lights L2, L3, L4 in the group 1, the update request DMAJ is capable of not being authorized by the group 1.

In these two cases mentioned above, the processing modules MT1, MT2, MT3, MT4 are configured to mark the at least one street light making the update request as an object likely to be failing or hacked.

Moreover, the update request DMAJ can, for example, be considered to be invalid by the processing modules MT1, MT2, MT3, MT4 if no other update request is detected at the end of a chosen delay, in this case for example, 24 hours, following the firmware update request DMAJ.

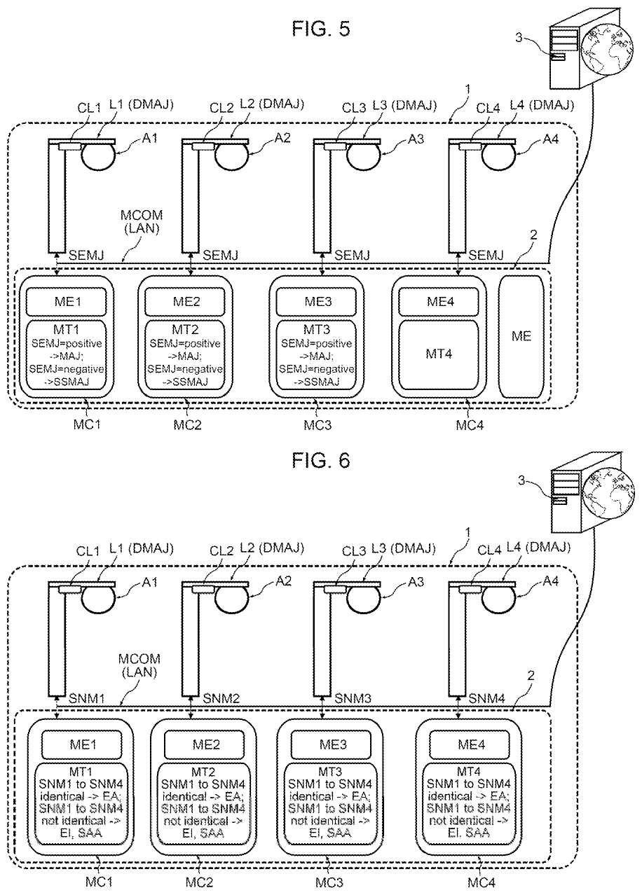

FIG. 5 illustrates another example implementation of the operation management system 2 when the exchange modules ME1, ME2, ME3, ME4 of all the connected street lights L1, L2, L3, L4 in the group 1 issue the same firmware update request DMAJ.

The control module 2 additionally comprises an election module ME coupled to the four street lights L1, L2, L3, L4 in the group 1, and configured to determine an elected street light LE, in this case for example, the street light 14 in the group 1.

Once the elected street light LE is determined, the processing module MT4 of the elected street light LE is configured to proceed with the firmware update (MAJ).

The exchange modules ME1, ME2, ME3, ME4 of each control module MC1, MC2, MC3, MC4 are then configured to exchange, within a chosen duration, in this case for example, 24 hours, following the firmware update MAJ of the elected street light LE, third items of information representative of an elected street light LE firmware update state, in this case for example, an update state signal SEMJ of the elected street light LE.

When the signal SEMJ is in its positive state, the processing modules MT1, MT2, MT3 of the other connected street lights L1, L2, L3 are configured to update firmware of the other connected street lights L1, L2, L3 in the group 1 with the same firmware as the elected street light LE.

When the signal SEMJ is in its negative state or at least one exchange of the signal SEMJ is not successful, the processing modules MT1, MT2, MT3 of the other connected street lights L1, L2, L3 are configured to suspend firmware updates of the other connected street lights in the group 1 and to issue a third warning signal, in this case for example, an update suspension signal SSMAJ.

FIG. 6 illustrates another example implementation of the operation management system 2 to verify the authentication of the firmware of the connected street lights L1, L2, L3, 14 in the group 1.

The exchange modules ME1, ME2, ME3, ME4 of each control module MC1, MC2, MC3, MC4 are configured to exchange with each other fourth items of information representative of a state of security of the street lights L1, L2, L3, L4 in the group 1, in this case, for example, a firmware digital signature SNM1, SNM2, SNM3, SNM4 known to the person skilled in the art.

The processing modules MT1, MT2, MT3, MT4 of each control module MC1, MC2, MC3, MC4 are additionally configured to determine an authentic state EA of all the street lights L1, L2, L3, L4 in the group 1 if the firmware digital signatures SNM1, SNM2, SNM3, SNM4 are identical, and to issue a fourth warning signal, in this case, for example, an authentication warning signal SAA, and determine a state of insecurity EI if the firmware digital signature SNM1, SNM2, SNM3, SNM4 of at least one street light L1, L2, L3, L4 is different from that of the other connected street lights.

By way of example, if the firmware digital signatures SNM1, SNM2, SNM3 of the street lights L1, L2, L3 are identical but different from that of the street light L4, the security of the group 1 can no longer be ensured and the group 1 is in the state of insecurity.

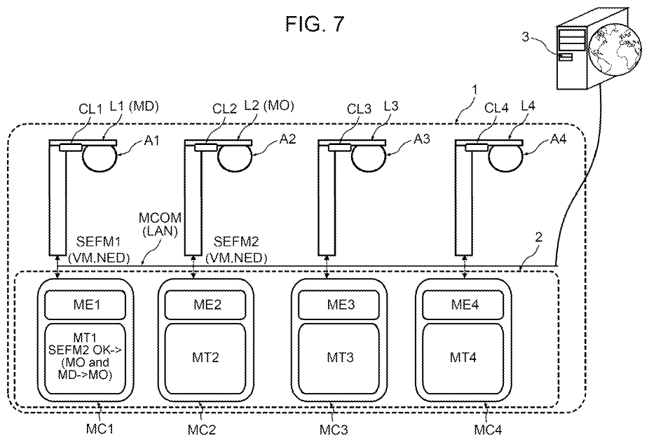

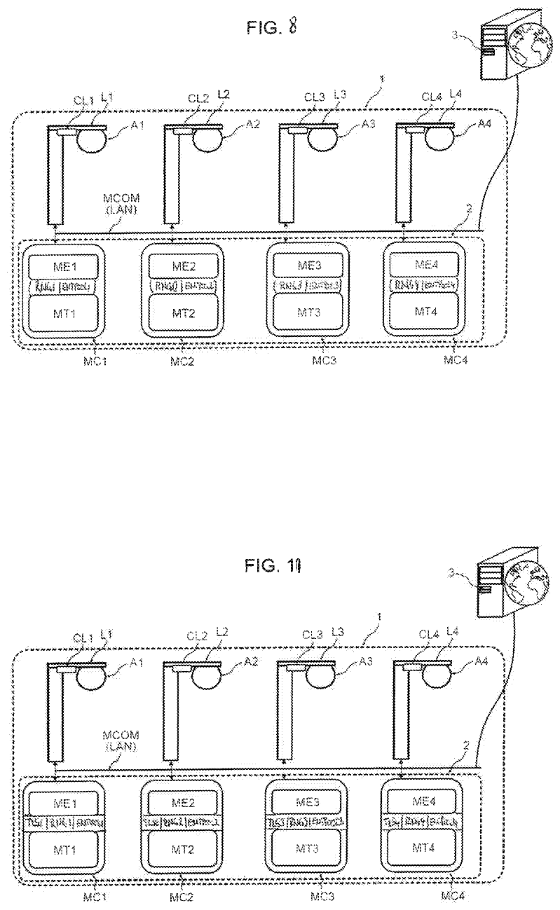

FIG. 7 illustrates yet another example implementation of the operation management system 2 when a street light, in this case for example, the street light L1, in the group 1, includes failing firmware MD.

The exchange modules ME1 of the control module MC1 are configured to exchange with at least one other connected street light, in this case for example, the street light L2, in the group 1, fifth items of information representative of a firmware operating state of the street light L1 and of the street light L2, in this case for example, firmware operating state signals SEFM1, SEFM2.

By way of non-limiting indication, each firmware operating state signal SEFM1, SEFM2 can comprise the version of the firmware VM used and a number of errors detected NED within a chosen duration, for example, one hour or one day, or a digital signature of the firmware VM.

If the firmware operating state signal SEFM2 of the street light L2 is positive, in other words the firmware of the street light L2 is operational, the processing module MT2 of the street light L2 are configured to deliver, under the request of the processing module MT1 of the street light L1, the operational firmware MO of the street light L2 to the first street light L1. The processing module MT1 of the street light L1 is configured to update its failing firmware MD with the operational firmware MO.

As a result, the connected street lights L1, L2, L3, L4 in the group 1 are capable of locally restoring one or more failing firmware MD.

As a variant, the remote control server 3 is configured to deliver, upon the request of the processing module MT1 of the street light L1, the operational firmware MO to the first street light L1.

The processing module MT1 of the street light L1 is configured to update its failing firmware MD with the operational firmware MO of the control server 3.

Thus, the connected street lights L1, L2, L3, L4 in the group 1 are also capable of remotely restoring one or more failing firmware MD.

Conventional solutions of cryptography applications in computing use random numbers but with objects (IoT) the randomness of these numbers is difficult to ensure. In computing the randomness is often collected from analog or hardware sources. Such sources can be a van (noise), a keyboard, a cryptoscopy, a mouse (movement), a mic, a light sensor etc. A lack of entropy/randomness can have a negative impact on the cryptographic performance of these devices. Typical entropy sources such as keyboard timings, mouse movements etc. are not available for IoTs as the user is not interacting with IoTs in such a way.

Embodiments provide a method for improving the entropy for objects (e.g., IoT) by multiplying the sources of entropy for each object. Further embodiments provide an efficient way to generate random numbers which are in turn important for cryptography.

Embodiments provide a group of mutually connected objects which are (substantially) identical. Objects are substantially identical when they have the same number and types of elements as, for example, described in FIG. 8 for street lights. Objects may also be considered substantially identical within this definition when one or more objects have a true random number generator (TRNG) while one or more other objects do not have a TRNG. Additional elements or variations of the described elements (such as a first street lamp with a first bulb configured to emit a certain first luminescence and/or radiation and a second street lamp with a second blub configured to emit a certain second different luminescence and/or radiation) do not preclude that the objects are considered substantially identical. This is also true with respect to functional or applicative features of, e.g., microcontrollers. In other words, all objects may have the microcontroller and all microcontroller have the same basic applicative features but some of the microcontrollers may have more than these basic applicative features.

Each object of the group feeds the entropy pool of other objects of the group so that the objects are entropy sources/producers and entropy consumers at the same time. Embodiments provide a mutualization of entropy so that each object does not only have access to its own source of entropy but also has access to other sources of entropy of the other objects in the group. Having access to a plurality of entropy sources is advantageous over having access to a single entropy source because it substantially increases the level of entropy.

Further, if an object takes a certain number of random data (symbols) out of the entropy pool for processing, it might be difficult for the object to fill the empty spots in the entropy pool with new random data (symbols) within a short period of time since the object itself might not be able to produce these random data (symbols) within a certain time frame. Having access to other objects may help filling up the entropy pool of the object faster or within the time frame.

It is further advantageous that a group of mutually connected objects can still provide a plurality of sources of entropy when one or more sources of entropy (objects) are down or not available because of, e.g., an attack. Based on this the group of mutually connected objects can be considered a reliable and resilient entropy provider.

Moreover, in other embodiments one or more objects can be a producer of entropy at one point in time and a consumer at another point in time. This duality of roles of the objects makes it more difficult for an attacker to attack the group of mutually connected objects.

Embodiments provide a group of mutually connected objects, for example, IoTs such as four connected external street lights L1, L2, L3, L4 as described in FIG. 1. The IoTs are intended to mutually communicate data and perform practical and more or less simple operations. The IoTs of the group of mutually connected objects may also be a group of connected luminous intensity detectors, a group of connected temperature detectors, a group of connected door-opening detectors and a group of connected electrical switches.

The objects communicate with each other in a secure manner, e.g., by encrypted communication encrypted with a symmetric or asymmetric key. An example for such a communication via symmetric or asymmetric key is described in U.S. patent application Ser. No. 17/007,599 titled “Key Generation Method.” This application is incorporate herein by reference in its entirety. In order to generate a reliable key a certain randomness is required.

FIG. 8 describes a group of mutually connected objects where each object maintains an entropy pool, wherein the entropy pool is fed from a plurality of entropy sources (other peer objects), and wherein the peer objects are identical or substantially identical.

The group of mutually connected objects may be a distributed system where each node (object) of the distributed system plays the same role. Any node may be a producer and/or a consumer of entropy. In various embodiments the distributed system does not have a centralized element, object or server that provides (exclusive or additional) entropy for the other objects.

As discussed with respect to FIG. 1, the group of connected objects includes street lights L1, L2, L3, L4, luminosity sensors CL1, CL2, CL3, CL4 and connected bulbs A1, A2, A3, A4. Each street light L1, L2, L3, L4 further comprises a control module MC1, MC2, MC3, MC4 coupled to the corresponding connected bulb A1, A2, A3, A4 and to the corresponding connected luminosity sensor CL1, CL2, CL3, CL4. The control module MC1, MC2, MC3, MC4 is configured to manage the operation of the corresponding street light L1, L2, L3, L4. Each control module MC1, MC2, MC3, MC4 may comprise a microcontroller such as a STM32®L4 microcontroller.

Each control module MC1, MC2, MC3, MC4 of the respective objects may comprise a true random number generator (TRNG), RNG1, RNG2, RNG3, RNG4 and an entropy pool ENTPOOL1, ENTPOOL2, ENTPOOL3, ENTPOOL4. The TRNG, RNG1, RNG2, RNG3, RNG4, may use a respective entropy pool ENTPOOL1, ENTPOOL2, ENTPOOL3, ENTPOOL4 to generate random numbers. An entropy pool stores random data (symbols) such as bits, e.g., 4096 bits.

The entropy pool (e.g., ENTPOOL1) may comprise a collection of symbols, e.g., a collection of bits. When the pool is fed with N input symbols (e.g., bits) from a source (e.g., L2) the added symbols may have “true” randomness. Randomness relates to the quality of randomness of the added symbols. If N symbols are added and if they are truly random, the N symbols have N bits of randomness (highest quality symbols). If the N symbols added have a lower quality than the N bits of randomness, the quality of the added symbols N can be calculated by x*N bits of randomness, wherein 0≤x≤1, such as 0.1(10%), 0.2 (20%), 0.5 (50%), 0.9 (90%), etc.

In various embodiments, only symbols with the highest quality of randomness are added (true random symbols). If the received symbols do not have the highest quality of randomness they are not added. Rather, the control module may apply a mixing and/or hash function to these symbols. The mixing and/or hash function may generate symbols (reduced in numbers from the originally received symbols) that are eventually added to the entropy pool. For example, the control module receives 12 symbols (with lower than the highest quality of randomness, e.g., a randomness of 2 bits), applies the mixing and/or hash function to these symbols and generates 2 symbols with a 2 bit randomness (by, e.g., mapping etc.). Only after applying the operation the 2 symbols are added to the entropy pool.

Alternatively, the symbols are added to the entropy pool without applying these functions but the control module keeps track about the quality of the symbols in the entropy pool or the overall quality of the entropy pool. For example, if the control module adds N symbols with lower quality (e.g., x=0.5) the quality of the randomness added to the entropy pool is 0.5*N, i.e., 0.5*N bits of randomness even though N symbols are added. Requesting symbols from other objects with a certain quality (by sending a request with an entropy quality parameter) may help the control module to ensure that the quality of randomness in the entropy pool does not fall under a certain threshold. In some embodiments, when the control module retrieves symbols from the entropy pool it may apply again a mixing and/or hash function to the entire pool so that the symbols extracted “come” from the entire entropy pool and have the entropy of the pool. In this situation, the control module may not remove symbols from the pool. Rather, the entropy indicator of the entropy pool is lowered by the number of symbols used. The control module may inject the symbols back in the pool in order to avoid “backtracking” attacks.

When the object (e.g., L1) receives incoming symbols from an entropy source of another object (e.g., L2) the control module MC1 may determine the quality of the incoming symbols. This can be done in several ways. The incoming symbols may comprise an accompanying indicator indicating a quality of randomness. Alternatively, the control module MC1 may determine the quality of the incoming symbols by knowing from which source these symbols come. For instance, if the control module MC1 receives 160 bits from a TRNG then the control module MC1 can assume that the 160 bits are truly random (having the highest quality), i.e., 160 bits of randomness is added to the entropy pool ENTPOOL1. If, however, the control module MC1 receives 12 bits from an analog-digital-converter (ADC) connected to the sensor CL2 of the other object L2 then the control modules MC1 might know that the (quality of) randomness of the sensor CL2 is low and that the received symbols (12 bits) only add 0.2*1232 2.4 bits of randomness when put into the ENTPOOL1.

The entropy pool ENTPOOL1 of one object L1 may be fed with entropy (symbols) from its own entropy source(s). Such an entropy source may be an analog device (connected to an ADC) which gathers environmental data. An example of such an analog device may be luminosity sensor CL1. Other analog devices may sense activity of the object node (of object L1) which connects the object L1 to the group of mutually connected objects 1 (e.g., via LAN). Here, the sensor may sense interrupts, LAN or bus activity, etc. The object L1 may have several different types of these analog devices. In various embodiments the control module MC1 may generate random data (symbols) by itself with its TRNG which is also fed to the entropy pool.

However, the entropy pool is also fed with random data (symbols) from the other objects (e.g., street lights L1, L2, L3, L4) of the group of mutually connected objects 1. The random data(symbols) from the other objects may come from remote locations since the peer objects may be located somewhere else. Accordingly, using the example with the luminosity sensor, CL1, CL2, CL3, CL4, the street lights L2, L3, L4, located at the different (remote) locations, may be exposed to different environmental conditions (such as lighting conditions). For example, some of the street lights L2, L3, L4 are located under tall trees or in streets with high buildings while others are located in places where no structure impedes the external light. Similarly, objects (e.g., lights or thermal sensors) may be located in different rooms of a building. The more random the random data (symbols) in the entropy pool the better the output of the random number generator using this data.

In various embodiments the control module MC1 of the object L1 of the group of mutually connected objects 1 is configured to maintain and strengthen its entropy pool ENTPOOL1. In order to do this the control module MC1 may request the other street lights L2, L3, L4 of the group 1 to send random data (symbols). Upon request, the other objects L2, L3, L4 provide random data (e.g., symbols), either via their TRNG RNG2, RNG3, RNG4 or by providing or otherwise calculating random data (symbols) from their respective entropy pool, ENTPOOL2, ENTPOOL3, ENTPOOL4. The control module MC1 then receives the random data (symbols) sent by the other objects L2, L3, L4. Of course, the example provided may apply to any of the other objects L2, L3, L4. The objects L1, L2, L3, L4 can perform the collection of entropy at the same time or at various different times.

In various embodiments, not all the objects L2, L3, L4 may provide random data (symbols). According to one example, the object L1 may only ask one or certain objects L2, L3, L4 of the plurality of objects 1 to provide the random data (symbols). In another example, one or more street lights L2, L3, L4 may be compromised and therefore not able to respond to the request. However, advantageously, the group of mutually connected objects 1 might have enough objects to provide random data (symbols) for the entropy pool of the control module MC1.

In various embodiments, object L1 requests random data (symbols) from the other object(s) L2, L3, L4 together with an entropy quality parameter. The quality parameter may indicate a required quality of randomness, the quality of randomness being selected from a different levels of quality: highest, 100%, high (e.g., 90% or more), medium (between 40%-60%), low (below 20% or below 10%). The quality parameter may also indicate a (requested) type of entropy source (e.g., a TRNG).

For example, the request with the entropy quality parameter may request that only symbols with highest quality of randomness should be provided, for example, produced by a TRNG. Other requests with the entropy quality parameter may ask for a specific type of entropy source. A type of entropy source could be a certain type of environmental sensor.

Providing random data (symbols) to an entropy pool of a certain object from peer objects of the group of mutually connected objects has the advantage that the random data might immediately be available. If these (remote) peer objects would not be available to provide random data to the object it might take the object a long time to gather all the random data to replenish the entropy pool.

Moreover, in some embodiment not all objects L2, L3, L4 have a TRNG. However, these objects may still be able to provide random data to object L1 by providing random data from their entropy sources.

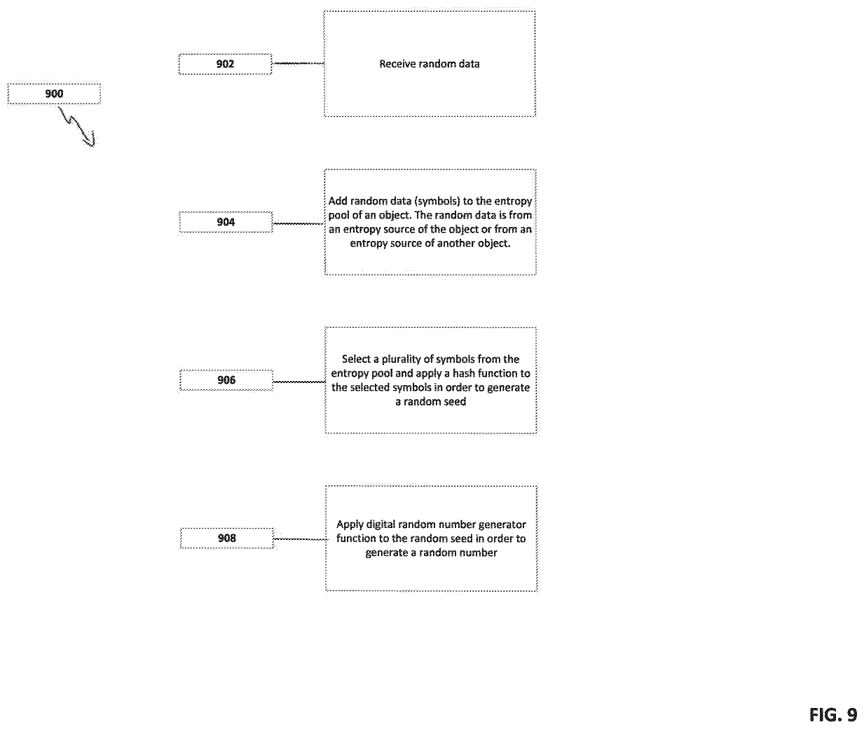

FIG. 9 shows a method 900 for generating a random number. For example, the control module MC1 can generate a random number from its entropy pool ENTPOOL1.

First, at 902, the control module MC1 receives random data (symbols such as bits) from a local entropy source or from its own TRNG, RNG1. Second, at 904, the control module MC1 adds the random data (symbols) to its entropy pool ENTPOOL1. The control module MC1 may request some or all other objects L2, L3, 14 of the group of mutually connected objects 1 to provide random data (symbols) to be added to the entropy pool ENTPOOL1 and adds the delivered random data (symbols) to the pool, ENTPOOL1. The random data (symbols) can be added to the entropy pool ENTPOOL1 at about the same time or sequentially one after the other at certain predetermined time intervals. Next, at 906, the control module MC1 selects a plurality of symbols at a time (such as four, eight, etc.) from the entropy pool ENTPOOL1 and applies a hash function to the selected symbols in order to generate a random seed. Afterwards, at 908, the control module MC1 applies a digital random number generator (drng) function to the random seed in order to generate a random number which can be used for cryptographic purposes.

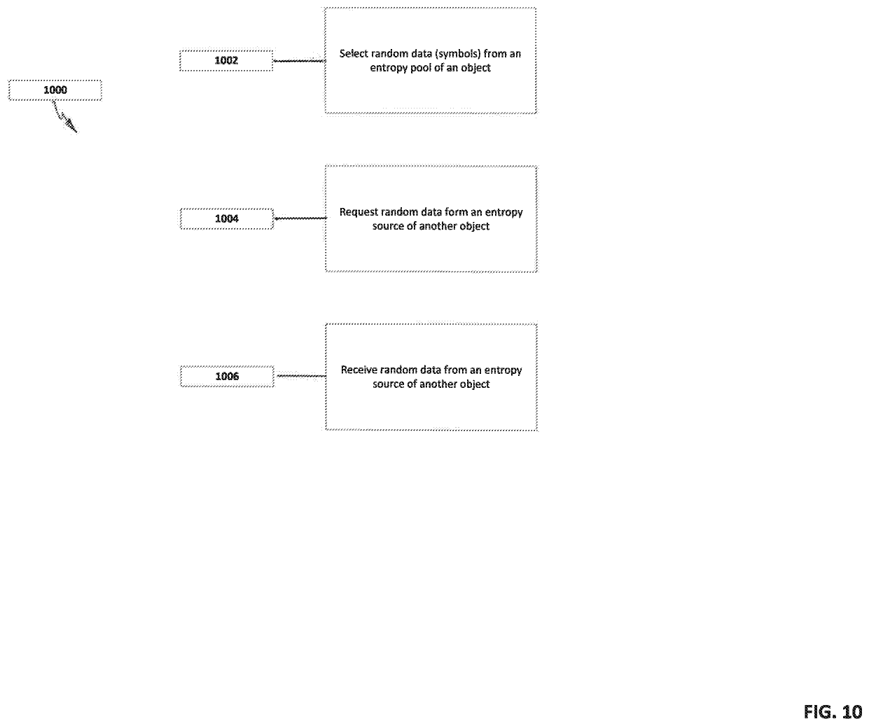

FIG. 10 shows a method 1000 for requesting random data, by an object from the group of mutually connected objects, from other objects of the group.

At 1002, the object selects a plurality of symbols from its entropy pool to generate, for example, a random number. The entropy pool may now be reduced by the number of selected symbols.

At 1004, in order to refill the entropy pool, the object requests random data (symbols) from other objects of the group of mutually connected objects. The request(s) may be sent to one or more specific objects of the group via a direct message or to all objects of the group via a broadcast message. The request may include an entropy quality parameter indicating a requested quality of randomness. The quality of randomness may be highest (e.g., 100%) or high (90% or more), etc.

At 1006, the object receives a response from the other objects providing the requested random data. All objects to which the requests were sent may respond. However, not all may provide random data. For example, some objects may not be able to fulfill the requirement to provide random data of the highest quality of randomness because they have no true random number generator. Moreover, some objects may not be able to respond because they are compromised or down.

After the object receives the random data, the control module may evaluate the random data received. If the random data is of the highest quality the control module may refill its entropy pool with the received data (symbols) without further processing. If the random data is a quality lower than the highest quality the control module may still refill the entropy pool with this random data (symbols). By knowing the quality of the random data put in the entropy pool, the control module can track the quality of the random data in the entropy pool. Alternatively, the control module can put the lower quality random data through a mixing and/or hash function. For example, if the control module receives 12 symbols of lower quality of randomness (e.g., randomness quality of 2 bits) the mixing and/or hash function may generate 2 symbols with randomness of 2 bits which then are put into the entropy pool.

The object may be able to replenish the entropy pool over a short period of time. In some circumstances, the object is able to replenish its entropy pool 10, 20, 100 or 1000 times faster and with a higher quality of randomness with the method using the mutual connected group of objects than with a method using just the entropy sources of the object which entropy pool is refilled.

FIG. 11 shows a group of mutually connected objects where the objects include the entropy management tool mbedTLS (Transport Layer Security) library.

Each object (IoT node) L1, L2, L3, L4 comprises a mbedTLS library, TLS1, TLS2, TLS3, TLS4. The mbedTLS, TLS1, TLS2, TLS3, TLS4 is a cryptographic library installed in each control module MC1, MC2, MC3, M4 or an associated memory of each object L1, L2, L3, L4. The mbedTLS, TLS1, TLS2, TLS3, TLS4 is an entropy collector that collects random data from one or more sources, supplies it to an entropy pool/source ENTPOOL1, ENTPOOL2, ENTPOOL3, ENTPOOL4 and manages that pool. For example, as discussed above, the entropy collector of the object (IoT node) L1 may collect random data from the analog sources (e.g., sensor CL1) of object L1, from the TRAN1 of L1 or from other objects (IoT nodes) L2, L3, L4 of the group of mutually connected objects 1.

The random generator TRAN, RAM, RAN2, RAN3, such as a CTR-DRBG module, uses its associated entropy pool ENTPOOL1, ENTPOOL2, ENTPOOL3, ENTPOOL4 to kick-start or refresh its own internal entropy state.

In various embodiments, it may be advantageous that the mbedTLS, TLS1, TLS2, TLS3, TLS4, which manages the entropy pool, knows the quality of the received random data. Accordingly, the mbedTLS of one object may request from other objects random data with a high quality of randomness. If the mbedTLS requests the highest quality of randomness only objects with a TRANG may be able to respond and provide such randomness because only a TRANG can produce the highest quality of randomness. If the mbedTLS receives the highest quality of randomness from other objects according to its request the object knows the quality of randomness and may not need to perform additional calculation. This is advantageous because it takes time to gather random data and it is complex to compute a good set of random data from a set of random data with low quality of randomness because complex calculations might need to be performed and assumptions need to be made. Moreover, objects which do not have a TRANG and therefore cannot locally produce highest quality of randomness may be able to receive the highest quality of randomness based on a request to other objects (having a TRNAG) to provide the highest quality of randomness.

Alternatively, the mbedTLS may request random data with a low quality of randomness or random data from a specific type of entropy source.

In various embodiments, if an object or node L1, L2, L3, L4 fails to respond to a request to send random data, other objects or nodes L1, L2, L3, L4 may answer the request for collecting random data. Accordingly, if a hacker is able to access one object or node the hacker is able to access the entropy pool (local entropy) of the accessed object or node. However, the hacker has no information about the entropy pools of the other objects or nodes. Moreover, since there is not a central object, node, element or server the hacker is not able to access all the objects or nodes because there are too many of them and therefore it is difficult for the hacker to shut down the service all together.

Embodiments of U.S. patent application Ser. No. 17/007,599 entitled “Key Generation Method,” which is incorporated herein by reference in its entirety, can be combined with all embodiments described in this description.

What is claimed is:

1. A method for generating a random number, the method comprising:
selecting, by a first object, first symbols from an entropy pool of the first object, wherein the first object is an object of a group of mutually connected objects which are substantially identical, and wherein the entropy pool is fed with second symbols by objects of the group of mutually connected objects;
applying, by the first object, a hash function to the first symbols to generate a random seed; and
generating, by the first object, the random number from the random seed.

2. The method of claim 1, further comprising:
receiving, by the first object, the second symbols from other objects of the group of mutually connected objects;
adding, by the first object, the second symbols to the entropy pool.

3. The method of claim 1, further comprising generating, by the first object, an encrypted key with the random number.

4. The method of claim 1, further comprising:
receiving, by the first object, a request from another object of the group of mutually connected objects to send third symbols;
sending, by the first object, the third symbols selected from the entropy pool to the other object.

5. The method of claim 1, further comprising:
requesting, by the first object, fourth symbols from another object of the group of mutually connected objects;
receiving, by the first object, the fourth symbols from the other object;
evaluating, by the first object, the fourth symbols;
adding, by the first object, the fourth symbols to the entropy pool when a entropy quality parameter is highest; and
modifying, by the first object, the fourth symbols before adding a modified and reduced set of fourth symbols to the entropy pool when the entropy quality parameter is not highest.

6. The method of claim 1, wherein the request includes an entropy quality parameter indicating a quality of randomness.

7. The method of claim 6, wherein the quality of randomness is x, and wherein 0≤x≤1.

8. The method of clam 1, wherein the first object is an internet of thing (IoT).

9. An object comprising:
a microcontroller;
a memory configured to store an entropy pool, wherein the entropy pool includes entropy from a group of mutually connected objects which are substantially identical, and wherein the object is an object of the group of mutually connected objects, and
wherein the microcontroller is configured to:
select first symbols from the entropy pool;
apply a hash function to the first symbols to generate a random seed; and
generate a random number from the random seed.

10. The object of claim 9, wherein the microcontroller is configured to:
receive second symbols from other objects of the group of mutually connected objects;
add the second symbols to the entropy pool.

11. The object of claim 9, wherein the microcontroller is configured to:
receive a request from another object of the group of mutually connected objects to send third symbols;
send the third symbols selected from the entropy pool to the other object.

12. The object of claim 9, wherein the microcontroller is configured to:
request fourth symbols from another object of the group of mutually connected objects;
receive the fourth symbols from the other object;
evaluate the fourth symbols;
add the fourth symbols to the entropy pool when an entropy quality parameter is highest; and
modify the fourth symbols before adding a modified and reduced set of fourth symbols to the entropy pool when the entropy quality parameter is not highest.

13. The object of clam 9, wherein the object is an internet of thing (IoT).

14. A method comprising:
requesting, by a first object, symbols from a second object, wherein the first and second objects are objects of a group of mutually connected objects which are substantially identical, and wherein the request includes an entropy quality parameter with a first threshold for the first symbols;
receiving, by the first object, the symbols from the second object when the symbols have a quality of randomness equal or higher than the threshold;
not receiving, by the first object, the symbols from the second object when the symbols have a quality of randomness below the threshold; and
adding the symbols to an entropy pool of the first object.

15. The method of claim 14, further comprising modifying, by the first object, the symbols before adding a modified and reduced set of the symbols to the entropy pool when the entropy quality parameter is not highest.

16. The method of claim 14, wherein the quality of randomness is x, and wherein 0≤x≤1.

17. The method of clam 16, wherein x=1

18. The method of clam 14, wherein the first and second objects are an internet of things (IoTs).
